(19) United States
(12) Patent Application Publication
(10) Pub. No.: US 2022/0075654 A1
(43) Pub. Date: Mar. 10, 2022

(54) OPTIMIZING RUNTIME FRAMEWORK FOR EFFICIENT HARDWARE UTILIZATION AND POWER SAVING

(71) Applicant: Telefonaktiebolaget LM Ericsson (publ), Stockholm (SE)

(72) Inventors: Konstantinos KOUKOS, Sollentuna (SE); Yashar NEZAMI, Ottawa (CA)

(21) Appl. No.: 17/419,370

(22) PCT Filed: Mar. 25, 2019
(86) PCT No.: PCT/IB2019/052411

§ 371 Date: Jun. 29, 2021

(51) Int. Cl. G06F 9/48; G06F 1/329

(52) U.S. Cl. CPC G06F 9/4893; G06F 1/329

(57) ABSTRACT

A system and method are disclosed for polling in a multi-thread computing system. In one embodiment, a method includes actively polling at least one work queue associated with a worker thread; as a result of the at least one work queue being 5 empty during the polling for a first period of time, causing the worker thread to alternately: poll the at least one work queue during at least one polling interval; and enter an autonomous sleep state during at least one sleep interval; and, as a result of the at least one work queue being empty during each polling interval of a back-off period, causing the worker thread to enter a non-autonomous sleep state for a yield 10 period controlled by a wake-up signal.

### TECHNICAL FIELD

Parallel computing and in particular, optimizing multi-thread computing methods and systems for efficient runtime hardware utilization and/or power savings.

### BACKGROUND

Massive parallel computing is a major driving force in computational science and industry. Such systems are becoming increasingly larger and more complex. There are quite a few frameworks such as Open Data Plane (ODP), Data Plane Development Kit (DPDK), Intel's Thread Building Blocks (TBB) for task parallelization, which may improve scalability and utilization of multi-core systems. Real-time systems, such as, for example, wireless communication 3^{rd} Generation Partnership Project (3GPP) 5^{th} Generation (5G) systems, depend greatly on advanced scheduling schemas and efficient resource utilization in order to, for example, provide latency critical services, particularly when targeting cloud deployments. At the same time, high-efficiency in the use of hardware resources (e.g., processor core(s), memory, etc.), as well as low-energy development principles should be employed to support such real-time systems. Unfortunately, balancing latency in real-time latency critical systems with efficient resource utilization and reducing power consumption is problematic.

### SUMMARY

Some embodiments advantageously provide a method and system for optimizing runtime frameworks for more efficient hardware utilization and power savings, as compared to existing systems.

According to one aspect of the present disclosure, a method in a multi-thread computing system is provided. The method comprises actively polling at least one work queue associated with a worker thread. The method comprises, as a result of the at least one work queue being empty during the polling for a first period of time, causing the worker thread to alternately: poll the at least one work queue during at least one polling interval; and enter an autonomous sleep state during at least one sleep interval. The method comprises, as a result of the at least one work queue being empty during each polling interval for a back-off period, causing the worker thread to enter a non-autonomous sleep state for a yield period controlled by a wake-up signal.

In some embodiments of this aspect, each of the at least one polling interval has a predetermined duration. In some embodiments of this aspect, each of the at least one sleep interval has a predetermined duration. In some embodiments of this aspect, a duration of each of the at least one sleep interval is varied from a first value to a second value during the back-off period, the first value being less than the second value. In some embodiments of this aspect, the at least one sleep interval comprises a plurality of sleep intervals being separated by a polling interval. In some embodiments of this aspect, a duration of each subsequent sleep interval of the plurality of sleep intervals is greater than a preceding sleep interval. In some embodiments of this aspect, the duration of each of the plurality of sleep intervals exponentially increases during the back-off period. In some embodiments of this aspect, a duration of the back-off period comprises any one or more of: a predetermined period of time; a predetermined number of polling intervals; and a predetermined number of sleep intervals. In some embodiments of this aspect, the duration of the back-off period is greater than the first period of time. In some embodiments of this aspect, entering the non-autonomous sleep state comprises the worker thread yielding by returning control and resources to a master thread. In some embodiments of this aspect, a duration of the yield period is based at least in part on a master thread of the worker thread. In some embodiments of this aspect, the wake-up signal is generated by a master thread of the worker thread. In some embodiments of this aspect, the wake-up signal comprises data being loaded into the at least one work queue associated with the worker thread.

According to another aspect of the present disclosure, a multi-thread computing system comprises processing circuitry. The processing circuitry is configured to actively poll at least one work queue associated with a worker thread. The processing circuitry is configured to, as a result of the at least one work queue being empty during the polling for a first period of time, cause the worker thread to alternately: poll the at least one work queue during at least one polling interval; and enter an autonomous sleep state during at least one sleep interval. The processing circuitry is configured to, as a result of the at least one work queue being empty during each polling interval for a back-off period, causing the worker thread to enter a non-autonomous sleep state for a yield period controlled by a wake-up signal.

In some embodiments of this aspect, each of the at least one polling interval has a predetermined duration. In some embodiments of this aspect, each of the at least one sleep interval has a predetermined duration. In some embodiments of this aspect, the duration of each of the at least one sleep interval is varied from a first value to a second value during the back-off period, the first value being less than the second value. In some embodiments of this aspect, the at least one sleep interval comprises a plurality of sleep intervals being separated by a polling interval. In some embodiments of this aspect, a duration of each subsequent sleep interval of the plurality of sleep intervals is greater than a preceding sleep interval. In some embodiments of this aspect, the duration of each of the plurality of sleep intervals exponentially increases during the back-off period. In some embodiments of this aspect, a duration of the back-off period comprises any one or more of: a predetermined period of time; a predetermined number of polling intervals; and a predetermined number of sleep intervals. In some embodiments, the duration of the back-off period is greater than the first period of time. In some embodiments of this aspect, the processing circuitry is further configured to cause the worker thread to enter the non-autonomous sleep state by being configured to cause the worker thread to yield by returning control and resources to a master thread. In some embodiments of this aspect, each of the first period of time and the back-off period is a predetermined period of time. In some embodiments of this aspect, the first period of time is less than the back-off period. In some embodiments of this aspect, a duration of the yield period is based at least in part on a master thread of the worker thread. In some embodiments of this aspect, the wake-up signal is generated by a master thread of the worker thread. In some embodiments of this aspect, the wake-up signal comprises data being loaded into the at least one work queue associated with the worker thread.

According to yet another aspect of the present disclosure, a non-transitory computer readable storage medium is provided. The non-transitory computer readable storage medium includes executable instructions which when executed by a multi-thread computing system cause the multi-thread computing system to execute any of the methods described herein.

According to yet another aspect of the present disclosure, a non-transitory computer readable storage medium including executable instructions, which when executed by a multi-thread computing system cause the processing circuitry of the multi-thread computing system to be configured according to any of the apparatuses described herein.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system including a multi-thread computing system according to the principles in the present disclosure;

FIG. 2 is a block diagram of an example of multi-thread computing according to some embodiments of the present disclosure;

FIG. 3 is a schematic diagram illustrating an example of a master thread spawning a plurality of worker threads, each worker thread having its own power saving policy according to some embodiments of the present disclosure;

FIG. 4 is a flowchart of an example process in a multi-thread computing system according to some embodiments of the present disclosure;

FIG. 5 is a flowchart of another example process in a multi-thread computing system according to some embodiments of the present disclosure; and

FIG. 6 is a timing diagram for an example worker thread power saving mechanism according to some embodiments of the present disclosure.

### DETAILED DESCRIPTION

In one aspect of the present disclosure, a method in a multi-thread computing system may be provided. The method may include, for each one of a plurality of worker threads instantiated in the multi-thread computing system:

actively polling one or more work queues associated with the worker thread;

responsive to the one or more work queues being empty during active polling for a first period of time, causing the worker thread to alternately actively poll the one or more work queues in predetermined polling intervals and enter a sleep state during predetermined sleep intervals; and

responsive to the one or more queues being empty during each polling interval for a back-off period, causing the worker thread to enter the sleep state for a yield period.

In some embodiments of this aspect, the duration of each sleep interval is varied from a first value to a second value during the back-off period, the first value being shorter than the second value. For example, the first value may be 1 nanosecond (nSec), and the second value may be 1 microsecond (uSec). In some embodiments of this aspect, the duration of the yield period is determined by a master thread of the multi-thread computing system. In some embodiments of this aspect, the wake-up signal is generated by the master thread. In some embodiments of this aspect, the conclusion of the yield period is associated with a predetermined event. For example, the predetermined event may correspond with data being loaded into the one or more work queues associated with the worker thread.

In some embodiments, the phrase “work queue” is used herein and may be used to indicate a structure (e.g., first-in-first-out array, register, memory, etc.) into which work is placed that enables deferral of processor processing of the work until a later time. In this context, the term “work-queue” or “task-queue” may be used interchangeably and may be used to indicate a function, operation, task, instruction, set of instructions, data, etc. that the system desires to schedule for processing by a processor. In some embodiments, the term “task” or “work” may be used to indicate a bulk/chunk of instructions that operates on a chunk of data.

In some embodiments, the term “empty” is used herein and may be used to indicate that a work queue does not have any tasks waiting in the work queue for processor processing.

In some embodiments, the phrase “worker thread” is used herein and/or may be used to indicate a thread, such as a kernel thread, that processes work/tasks in a work queue on one of the system's processors. Each worker thread may be configured to carry out a different function and may be assigned to one work queue and one processor. The worker thread may extract tasks from its assigned work queue to be processed by its assigned processor. The worker thread may be controlled by a master thread. The “master thread” may be a thread that spawns worker threads. The master thread may schedule and/or move tasks between its worker threads at runtime and/or manage its worker threads.

In some embodiments, the term “polling” is used herein and/or may be used to indicate a worker thread checking the work queue for any tasks. The time period during which the worker thread polls its work queue may be referred to as a “polling interval.” In this context, the phrase “active polling” may be used to differentiate between actively polling at a high rate (e.g., every clock cycle, every 1-3 nanosecond (ns), etc.) and polling in between increasing sleep intervals (e.g., polling and then sleeping for hundreds of nanoseconds (e.g., 300-500 ns), sleeping on the order of milliseconds, etc.), such as via the back-off feature described in this disclosure.

In some embodiments, the term “sleep” or the phrase “enter a sleep state” may be used interchangeably and/or may be to indicate a worker thread being asleep or suspended for a period of time, which may be referred to herein as a “sleep interval”, during which period of time the worker thread does not consume processor resources.

In some embodiments, the term “yield” is used herein and/or may be used to indicate the worker thread and/or the master thread yielding via releasing the hardware resources (i.e. the processor) to the kernel scheduler; whom in terms decides to allocate such resources to another thread/process or put it into a deep sleep state for the next timeslot/quantum/period of time.

In some embodiments, the phrase “exponentially increasing” is used herein and/or may be used to indicate exponentially increasing sleep intervals, where, for example, each subsequent sleep interval (in between polling intervals) may become increasingly larger until, for example, a certain condition is met. The condition may be, for example, that the work queue has been empty for a predetermined period of time, which may be referred to as a back-off period.

In some embodiments, the term “autonomous” may be used herein and/or may be used to indicate a sleep state of a worker thread in which the worker thread can wake itself up from out of such sleep state, e.g., without having to wait for an external signal. In some embodiments, the term “non-autonomous” may be used herein and/or may indicate a sleep state of a worker thread in which the worker thread wakes-up from the sleep state as a result of an external signal. To elaborate, the runtime system typically includes two parts: one or more master threads, responsible for issuing work to the worker queues and the worker threads. When a worker thread enters a sleep state, it is generally most likely woken up by the kernel. In some embodiments, a worker thread's sleep state may be considered “autonomous” in the sense that it does not require an explicit signal from one of the master threads to resume; as opposed to the yielding where the wake-up process may be explicitly performed or initiated by a master thread using a signaling mechanism (e.g. external signal). Because such external signal is sent by the master thread some overhead to the master thread may be incurred.

Having described at least some of the terminology that may be used in this disclosure to discuss the techniques provided in this disclosure, a detailed description of some example embodiments and some of the advantages which may be gained (as compared to existing systems) is provided below.

In attempting to balance latency with efficient resource utilization, existing state-of-the-art frameworks, such as those discussed above, tend to perform a static resource allocation based on the highest compute demand of an application, and rarely adapt to varying/dynamic conditions. For example, since resource (e.g., thread/core) allocation is an expensive operation (e.g., time), such systems typically allocate these resources at system startup and rarely deallocate or reallocates them. To allow for low-latency notification upon incoming work, such systems typically employ active polling mechanisms, which tend to be extremely power aggressive. For example, an active polling mechanism that polls for incoming work requests every cycle (e.g., every central processing unit (CPU) cycle) consumes a large amount of power; however, by polling at such a high rate, the system is very responsive to incoming requests, which is desirable to reduce latency.

Unfortunately, one drawback with this approach is that the operational cost is significantly higher than may be needed, as such systems are optimized only for the highest-demand case scenario, disregarding long idle or lower demand periods on the network. Operational cost may be considered the aggregate of energy consumption due to active-polling and increased cooling demands when the system operates constantly at high utilization.

Another drawback with this approach relates to performance, thermal considerations and system utilization. State-of-the-art hardware provides several performance states that an application can operate. Depending on the overall utilization of the multi-core system, the processor can freely decide upon the operation frequency (i.e., clock rate) of the processor cores based on one or more of, e.g.: how many cores are active and in which state the cores are in, the temperature of the chip, the energy demands of the instruction stream per core, etc. Such mechanisms may be employed to confine the cores within a reasonable thermal budget, but may also have a major impact in the performance per thread as system utilization increases. Furthermore, there is a correlation between one processor core's performance and the activity of another processor core. For example, as an entire CPU gets warmer and/or the peak thermal design power (TDP) is approached, the operation frequency may be reduced for all cores.

Therefore, the active polling mechanisms can introduce problems negatively impacting performance, energy efficiency and scalability of the application(s). At the same time, it is desirable to maintain the low latency and responsiveness of such active polling systems in order to preserve the hard-real-time execution demands of the target application(s), and, in particular real-time applications, such as for example applications processing network communications with Quality of Service (QoS) requirements, such as, those in 5G.

Accordingly, the present disclosure provides techniques for optimizing a runtime framework for more efficient hardware utilization and power savings (as compared to existing systems).

In some embodiments, recognizing the overhead of resource allocation, static resource allocation may be used at system startup, similar to other frameworks. However, instead of merely employing active polling mechanisms as described above with other systems, the present disclosure provides for a hybrid approach for work polling when worker queues are empty. For example, in some embodiments, active polling may be used for a small amount of time, followed by one or more periods of short duration sleep (e.g., using exponential back-off sleep), and, at longer periods of inactivity, invoking yield and signaling mechanisms so that, for example, resources may be released back to the operating system (OS) if e.g., the worker queue is empty for a predetermined period of time.

The present disclosure proposes a solution that attempts to provide a highly-efficient system utilization, while also providing low power consumption (as compared to existing systems), particularly during time periods when there is a limited need for compute resources. For example, when a multi-thread system is servicing 5G consumers during the evening hours when most of the worker-threads are not awake (i.e., asleep), the techniques disclosed herein may be capable of e.g., recognizing these time periods and gradually yielding resources back to the OS (e.g., using exponential back-off of sleep durations) to e.g., reduce power consumption and thermal impact efficiently. Some embodiments of the present disclosure also advantageously allow for higher performance of active worker threads in low or moderate system utilization (e.g., since non-active worker threads can yield and therefore no longer increase the thermal impact on system performance). Some embodiments of the present disclosure may also maintain high responsiveness to incoming work, which may be equally responsive as non-hybrid active polling mechanisms.

Before describing in detail example embodiments, it is noted that the embodiments reside primarily in combinations of apparatus components and processing steps related to optimizing runtime framework for efficient hardware utilization and power saving. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments described herein, the term “coupled,” “connected,” and the like, may be used herein to indicate a connection, although not necessarily directly, and may include wired and/or wireless connections.

The term “computing node” used herein can be any kind of computing node such as, for example, a network node comprised in a network which may further comprise any of a scheduler, a base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), server computer, computer, tablet computer, etc. The computing node may also comprise test equipment. The term “radio node” used herein may be used to also denote a wireless device (WD) such as a wireless device (WD) or a radio computing node, which may be implemented as a multi-thread computing system according to the techniques described herein.

In some embodiments, the non-limiting terms wireless device (WD) or a user equipment (UE) are used interchangeably. The WD herein can be any type of wireless device capable of communicating with a computing node or another WD over radio signals, such as wireless device (WD). Note further, that functions described herein as being performed by multi-thread computing system may be distributed over a plurality of computing systems and/or a plurality of processors. In other words, it is contemplated that the functions of the multi-thread computing system described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

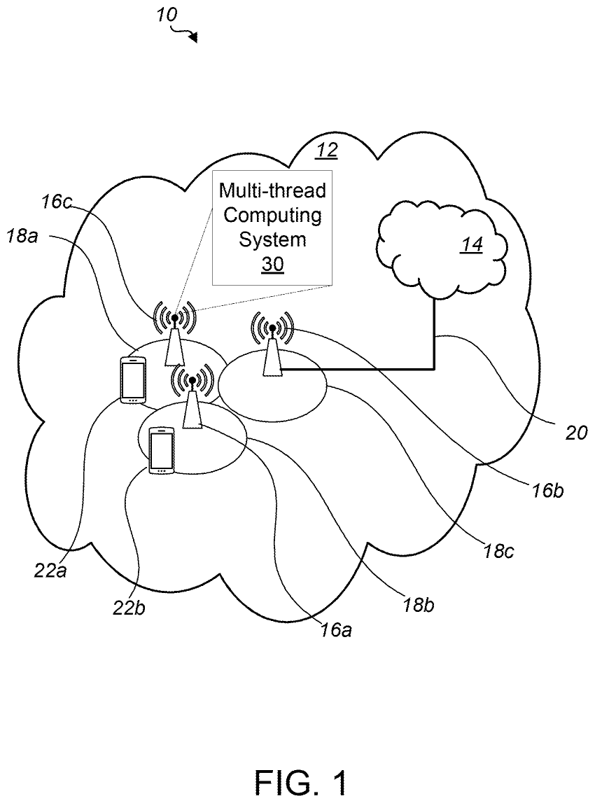

Referring now to the drawing figures, in which like elements are referred to by like reference numerals, there is shown in FIG. 1 a schematic diagram of a communication system 10, according to one example embodiment, such as a 3GPP-type cellular network that may support standards such as LTE and/or NR (5G), which comprises an access network 12, such as a radio access network, and a core network 14. The access network 12 comprises a plurality of computing nodes 16a, 16b, 16c (referred to collectively as computing nodes 16), such as, for example, NBs, eNBs, gNBs or other types of wireless access points, each defining a corresponding coverage area 18a, 18b, 18c (referred to collectively as coverage areas 18). Each computing node 16a, 16b, 16c is connectable to the core network 14 over a wired or wireless connection 20. A first wireless device (WD) 22a located in coverage area 18a is configured to wirelessly connect to, or be paged by, the corresponding computing node 16c. A second WD 22b in coverage area 18b is wirelessly connectable to the corresponding computing node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding computing node 16. Note that although only two WDs 22 and three computing nodes 16 are shown for convenience, the communication system may include many more WDs 22 and computing nodes 16.

Also, it is contemplated that a WD 22 can be in simultaneous communication and/or configured to separately communicate with more than one computing node 16 and more than one type of computing node 16. For example, a WD 22 can have dual connectivity with a computing node 16 that supports LTE and the same or a different computing node 16 that supports NR. As an example, WD 22 can be in communication with an eNB for LTE/E-UTRAN and a gNB for NR/NG-RAN.

A computing node 16 may be configured to include a multi-thread computing system 30 (e.g., one or more multi-core processor(s)), which may be configured to actively poll at least one work queue associated with a worker thread; as a result of the at least one work queue being empty during the polling for a first period of time, cause the worker thread to alternately: poll the at least one work queue during at least one polling interval; and enter an autonomous sleep state during at least one sleep interval; and as a result of the at least one work queue being empty during each polling interval for a back-off period, causing the worker thread to enter a non-autonomous sleep state for a yield period controlled by a wake-up signal. Use of the multi-thread computing system 30 in the communication system 10 may be particularly beneficial to the network for scheduling and processing packets in real-time to meet low latency communication requirements.

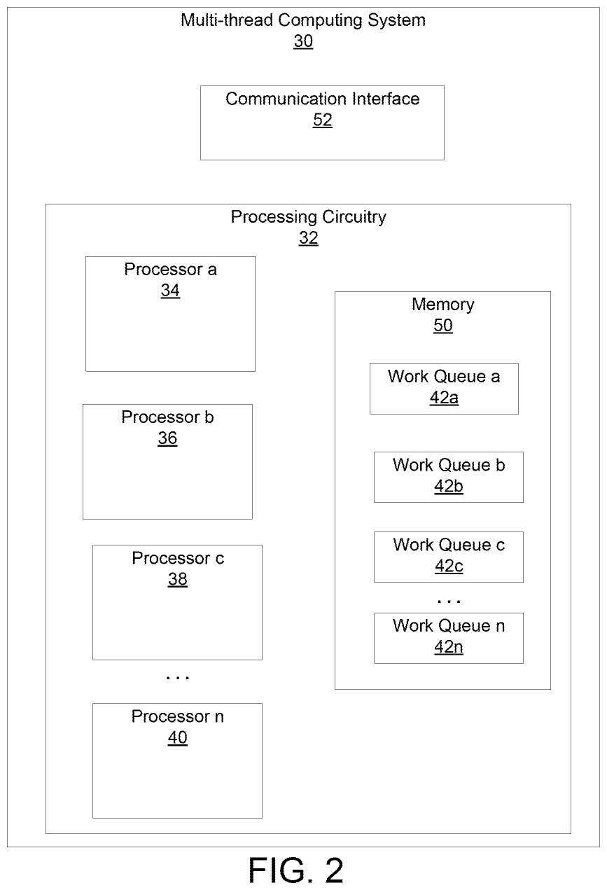

Although the multi-thread computing system 30 is shown within a computing node 16 and as part of a wireless communication system 10, is it understood that the concepts, principles and embodiments shown and described herein can be applied and used in environments that are not limited to wireless and other network communications. For example, the arrangements shown and described herein can be implemented in a cloud computing environment without regard to whether that environment is used to support/provide wireless communications. For example, the techniques disclosed herein may be beneficial for any multi-thread computing system running any real-time applications, where reduced latency is desired. Thus, it is understood that computing node 16 need not be part of wireless communication network and can be any computing node where multi-thread operations are implemented. Similarly, although the multi-thread computing system 30 is shown within a computing node 16, it is contemplated that the multi-thread computing system 30 can be implemented as part of a WD 22. FIG. 2 illustrates an example of the multi-thread computing system 30, which may be used in a variety of different environments. The multi-thread computing system 30 may include processing circuitry 32. The processing circuitry 32 may comprise a plurality of processors, such as processor a 34, processor b 36, processor c 38 and processor n 38 (where “n” can be any number greater than 1). The plurality of processors may be referred to collectively as processors, or more generally, the processing circuitry 32. In some embodiments, each processor may be considered a processor core in a multi-core processor. In some embodiments, the processor may be a central processing unit. The processing circuitry 32 may include one or more multi-core processors. The processing circuitry 32 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor and/or the processing circuitry 32 may be configured to access (e.g., write to and/or read from) memory, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Each processor 34, 36, 38 and 40 may be associated with a corresponding work queue 42a, 42b, 42c, 40n (referred to collectively as work queue 42). In some embodiments, the work queue 42 may be in cache memory, or be otherwise present on each corresponding processor 34, 36, 38 and 40. In other embodiments, the work queue 42 may be in the memory 50. The memory 50 is configured to store data, programmatic software code and/or any other information described herein. In some embodiments, the memory 50 may be accessible by the processors 34, 36, 38 and 40 over a communication bus. In some embodiments, the applications may include instructions that, when executed by the one or more processors 34, 36, 38 and 40 and/or processing circuitry 32, causes the one or more processors 34, 36, 38 and 40 and/or processing circuitry 32 to perform the processes described herein with respect to the multi-thread computing system 30.

In some embodiments, the multi-thread computing system 30 may include a communication interface 52. The communication interface 52 may be responsible for setting up and maintaining a wired or wireless connection with an interface of a different communication device in communication with the multi-thread computing system 30, such as a device of the communication system 10. The communication interface 52 may also include a radio interface for setting up and maintaining at least a wireless connection. The radio interface may be formed as or may include, for example, one or more RF transmitters, one or more RF receivers, and/or one or more RF transceivers. In some embodiments, the tasks executed by the processors 34, 36, 38 utilizing the back-off sleep techniques disclosed herein may be for implementing low latency wireless communications in the communication system 10 (e.g., wireless communications between the computing node 16 and WDs 22). In other embodiments, the tasks executed by the processors 34, 36, 38 and 40 utilizing the back-off sleep techniques disclosed herein may be for other real-time applications. The processing circuitry 32 may be configured to control any of the methods and/or processes described herein and/or to cause such methods, and/or processes to be performed, e.g., by the multi-thread computing system 30. Processors, such as processor 34, 36, 38 and 40, may perform any of the multi-thread computing system 30 functions described herein.

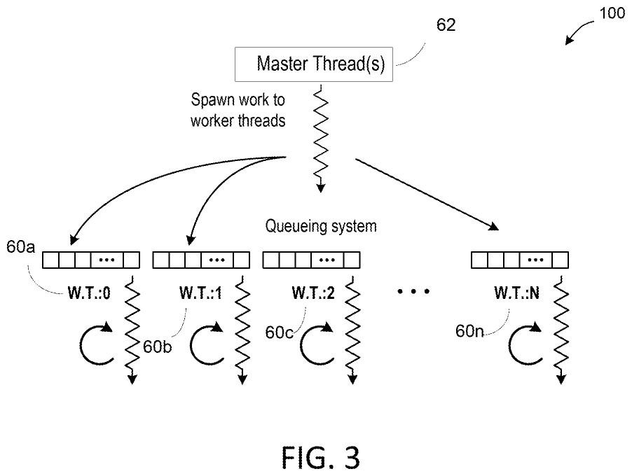

Referring to FIG. 3 in conjunction with FIG. 2, the work queues 42 may be polled by corresponding worker threads 60a, 60b, 60c and 60n (referred to collectively as worker thread 60) for tasks and processed by the corresponding worker thread 60 on the corresponding processor 34, 36, 38 and 40. Each of the worker threads 60 may be assigned to one of the processors 34, 36, 38 and 40 and may be controlled by a master thread 62. In some embodiments, each of the worker threads 60 may implement an independent idling policy per thread such as by using the back-off sleep techniques in this disclosure. Components in the memory 50, such as applications, may be executable by the processing circuitry 32 and/or one or more of the processors 34, 36, 38 and 40 via one or more of the work queues 42 and corresponding worker threads 60 according to the techniques in this disclosure. For example, processing circuitry 32 of the multi-thread computing system 30 be configured to actively poll at least one work queue associated with a worker thread 60; as a result of the at least one work queue being empty during the polling for a first period of time, cause the worker thread 60 to alternately: poll the at least one work queue 42 during at least one polling interval; and enter an autonomous sleep state during at least one sleep interval; and, as a result of the at least one work queue 42 being empty during each polling interval for a back-off period, causing the worker thread 60 to enter a non-autonomous sleep state for a yield period controlled by a wake-up signal.

In some embodiments, each of the at least one polling interval has a predetermined duration. In some embodiments, each of the at least one sleep interval has a predetermined duration. In some embodiments, a duration of each of the at least one sleep interval is varied from a first value to a second value during the back-off period, the first value being less than the second value. In some embodiments, the at least one sleep interval comprises a plurality of sleep intervals being separated by a polling interval. In some embodiments, a duration of each subsequent sleep interval of the plurality of sleep intervals is greater than a preceding sleep interval. In some embodiments, the duration of each of the plurality of sleep intervals exponentially increases during the back-off period. In some embodiments, a duration of the back-off period comprises any one or more of: a predetermined period of time; a predetermined number of polling intervals; and a predetermined number of sleep intervals. In some embodiments, the duration of the back-off period is greater than the first period of time. In some embodiments, the polling of the at least one work queue 42 during the at least one polling interval occurs in between each one of the plurality of sleep intervals until a predetermined condition is met. In some embodiments, the predetermined condition corresponds to the worker thread 60 entering the non-autonomous sleep state. In some embodiments, the processing circuitry 32 is further configured to cause the worker thread 60 to enter the non-autonomous sleep state by being configured to cause the worker thread 60 to yield by returning control and resources to a master thread 62. In some embodiments, each of the first period of time and the back-off period is a predetermined period of time. In some embodiments, the first period of time is less than the back-off period. In some embodiments, a duration of the yield period is based at least in part on a master thread 62 of the worker thread 60. In some embodiments, the wake-up signal is generated by a master thread 62 of the worker thread 60. In some embodiments, the wake-up signal comprises data being loaded into the at least one work queue 42 associated with the worker thread 60.

In some embodiments, a non-transitory computer readable storage medium includes executable instructions, which when executed by a multi-thread computing system 30 cause the multi-thread computing system 30 to execute any one of the methods described herein.

In some embodiments, a non-transitory computer readable storage medium includes executable instructions, which when executed by a multi-thread computing system 30 cause the processing circuitry 32 of the multi-thread computing system 30 to be configured according to any of the techniques disclosed herein.

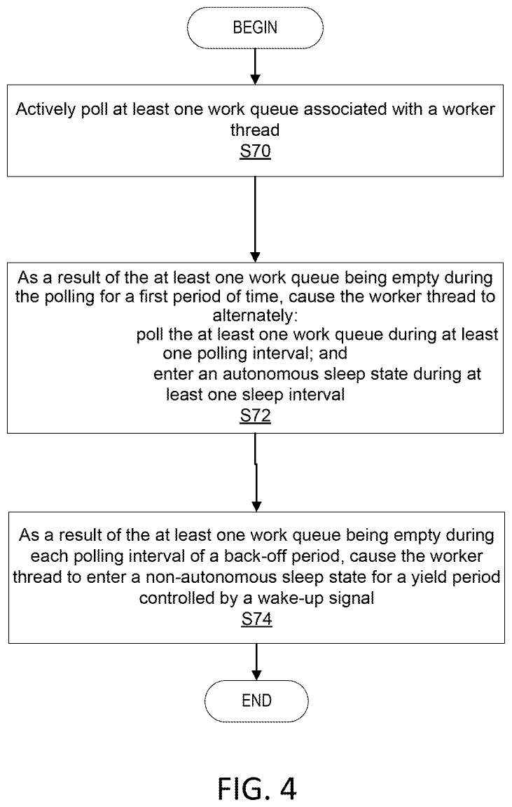

FIG. 4 is a flowchart of an example method in a multi-thread computing system 30 according to some embodiments of the present disclosure. One or more Blocks and/or functions and/or methods performed by the multi-thread computing system 30 may be performed by one or more elements of multi-thread computing system 30 such as by worker thread 60 and/or master thread 62 in and/or using processing circuitry 32, processor 34, 36, 38, 40, communication interface 52, etc. according to the example method. The example method includes actively polling (Block S70), such as via the processing circuitry 32, at least one work queue 42 associated with a worker thread 60. The method includes, as a result of the at least one work queue 42 being empty during the polling for a first period of time, causing (Block S72), such as via processing circuitry 32, the worker thread 60 to alternately: poll the at least one work queue during at least one polling interval; and enter an autonomous sleep state during at least one sleep interval. The method includes, as a result of the at least one work queue 42 being empty during each polling interval for a back-off period, causing (Block S74) the worker thread 60 to enter a non-autonomous sleep state for a yield period controlled by a wake-up signal.

In some embodiments, each of the at least one polling interval has a predetermined duration. In some embodiments, each of the at least one sleep interval has a predetermined duration. In some embodiments, a duration of each of the at least one sleep interval is varied from a first value to a second value during the back-off period, the first value being less than the second value. In some embodiments, the at least one sleep interval comprises a plurality of sleep intervals being separated by a polling interval. In some embodiments, a duration of each subsequent sleep interval of the plurality of sleep intervals is greater than a preceding sleep interval. In some embodiments, the duration of each of the plurality of sleep intervals exponentially increases during the back-off period. In some embodiments, a duration of the back-off period comprises any one or more of: a predetermined period of time; a predetermined number of polling intervals; and a predetermined number of sleep intervals. In some embodiments, the polling, such as via processing circuitry 32, of the at least one work queue 42 during the at least one polling interval occurs in between each one of the plurality of sleep intervals until a predetermined condition is met. In some embodiments, the predetermined condition corresponds to the worker thread 60 entering the non-autonomous sleep state. In some embodiments, entering the non-autonomous sleep state comprises the worker thread 60 yielding by returning control and resources to a master thread 62. In some embodiments, each of the first period of time and the back-off period is a predetermined period of time. In some embodiments, the first period of time is less than the back-off period. In some embodiments, a duration of the yield period is based at least in part on a master thread 62 of the worker thread 60. In some embodiments, the wake-up signal is generated by a master thread 62 of the worker thread 60. In some embodiments, the wake-up signal comprises data being loaded into the at least one work queue 42 associated with the worker thread 60.

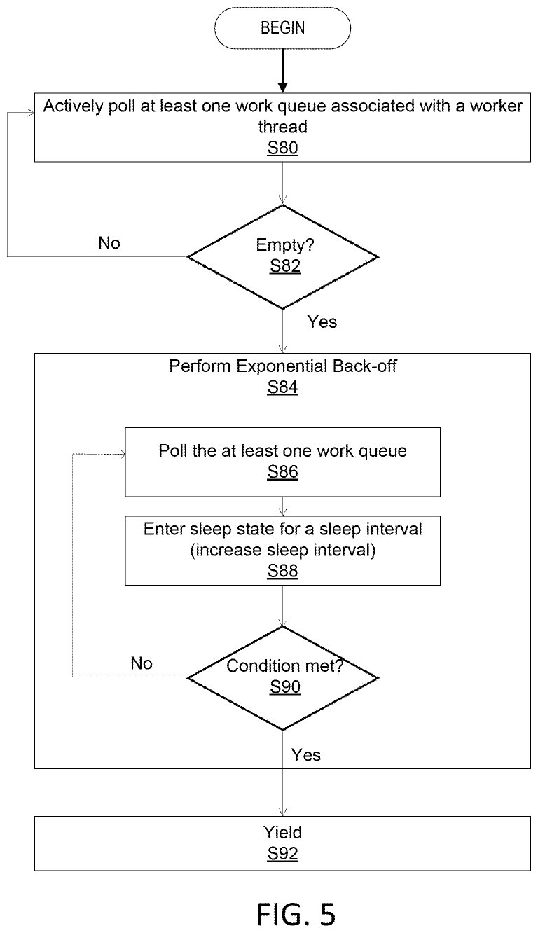

FIG. 5 is a flowchart illustrating an example method in the multi-thread computing system 30 polling work queues according to some embodiments of the present disclosure for e.g., optimizing a runtime framework for more efficient hardware utilization and power savings. As illustrated in FIG. 4, in some embodiments, there is a master thread 62, or main thread of control that spawns tasks to each worker thread 60 through a queue system. Each worker thread 60 may have its own private work queue 42 (although a global queue may be present in the system to allow for load balancing through work stealing). Initially, a spin lock may be used for a short duration of time to ensure that the system 30 is highly responsive in high-load periods. Spin lock is well-known in the art and therefore will not be described in detail herein. Spin lock does not provide any energy savings, and therefore, a low overhead mechanism may be used in order to provide an intermediate level of energy savings. This may be achieved by sleeping for a sleep interval (e.g., a few nanoseconds). However, a static approach may not adapt very well to dynamic situations; therefore, some embodiments of the present disclosure propose use of an increasing latency schema (e.g., exponentially increasing latency schema).

The example method in FIG. 5 includes actively polling (Block S80), such as by the worker thread 60 via processing circuitry 32, the work queue 42 associated with the worker thread 60. When the queue(s) 42 that each worker thread 60 is responsible to poll is empty a polling mechanism may be used to ensure that upon a new task in the queue, the worker thread 60 will be able to respond and start executing it, within a reasonable amount of time. However, if the work queue 42 has been empty for a long period of time, another polling mechanism may be used to balance responsiveness with power savings, if desired. The method includes determining (Block S82), such as by the worker thread 60 via processing circuitry 32, whether the work queue 42 has been empty for a period of time, such as a predetermined period of time, which may trigger the techniques disclosed herein. If the work queue 42 has not been empty for the period time, the method may return to Block S80, where the actively polling continues. If the work queue 42 is determined to be empty for the period of time, the method may perform (Block S84), such as by the worker thread 60 via processing circuitry 32, the exponential back-off. In one embodiment, the exponential back-off may be performed by polling (Block S86) the at least one work queue 42 for a polling interval. The method includes entering (Block S88), such as by the worker thread 60 via processing circuitry 32, a sleep state for a sleep interval. The method includes determining (Block S90), such as by the worker thread 60 via processing circuitry 32, whether a predetermined condition is met. The predetermined condition may be, for example, a threshold period of time. If the condition is not met, the method returns to Block S86 and repeats Blocks S86, Block S88 and Block S90, except that the duration of the sleep interval in Block S88 may be increased for each iteration. In some embodiments, the increase in the duration of each subsequent sleep interval may be considered exponential. In some embodiments, when an exponentially backed-off sleep duration exceeds a certain duration, its overhead threshold may no longer justify its benefit and a more-delicate (and heavy-weight) mechanism may be used, such as yield on the worker thread. In such cases, a signal (e.g., a signaling mechanism through the kernel and/or using kernel invocation) by the control thread can be safely employed. Thus, the method includes, if the threshold condition is met, yielding (Block S92) the corresponding processor 34, 36, 38 or 40 to the OS.

It should be understood that, although FIGS. 4 and 5 correspond to separately described methods, in some embodiments, the methods may overlap, such as, FIG. 5 may be considered one implementation of the more general process described with reference to FIG. 4. For example, S80 and S82 may be one example implementation of S70; S84-S90 may be one example implementation of S72; and/or S92 may be one example implementation of S74.

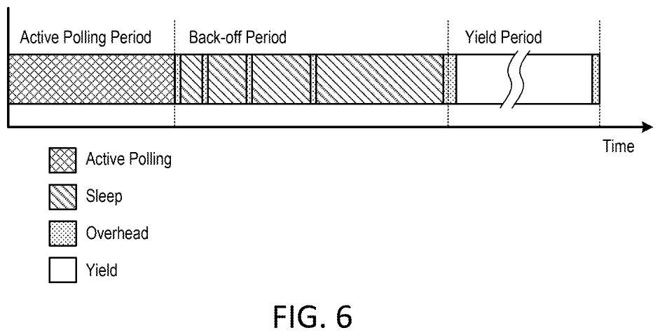

In contrast to existing active polling mechanisms, some embodiments of the present disclosure provide a per worker thread 60 mechanism configured to preserve a low response latency, while simultaneously providing good energy savings and may be used by each worker thread 60. Some embodiments of the polling mechanism of the present disclosure may be considered to employ a hybrid approach of active polling, sleep, and yield as described herein. One example of the results of such polling mechanism is shown in FIG. 6. FIG. 6 is a timing diagram for the worker thread power saving mechanism. As can be seen in FIG. 6, a duration of each subsequent sleep interval is greater than a preceding sleep interval until the worker thread 60 yields (or, equivalently, enters the non-autonomous sleep state). The worker thread 60 does not wake-up from this yield state until a wake-up signal is received; thus, the time period during which the worker thread 60 is asleep after the yield may be dependent on a signal from the master thread 62. When such wake-up signal is received, the worker thread 60 may return to active polling until the exponential back-off sleep mechanism is triggered again.

The overall approach in the present disclosure provides for a gradual/progressive energy savings policy per worker thread. In some embodiments, when the mechanism is initially invoked, there may be a very limited potential for energy savings in order to keep the system highly responsive (based on previous history). As the mechanisms progresses, without work demand, the system uses the mechanism to exponentially exploit the possibility for energy savings by using successively increasing sleep intervals. Some embodiments also provide the option to put some of the pre-allocated cores to long-term sleep (e.g., when a predetermined condition is met). Therefore, some embodiments of the present disclosure enable an active thread reconfiguration on-the-fly without having to release pre-allocated resources right away.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a multi-thread computing system, the method comprising:
actively polling at least one work queue associated with a worker thread;
as a result of the at least one work queue being empty during the polling for a first period of time, causing the worker thread to alternately:
poll the at least one work queue during at least one polling interval; and
enter an autonomous sleep state during at least one sleep interval; and
as a result of the at least one work queue being empty during each polling interval of a back-off period, causing the worker thread to enter a non-autonomous sleep state for a yield period controlled by a wake-up signal.

2. The method of claim 1, wherein each of the at least one polling interval has a predetermined duration.

3. The method of claim 1, wherein each of the at least one sleep interval has a predetermined duration.

4. The method of claim 1, wherein a duration of each of the at least one sleep interval is varied from a first value to a second value during the back-off period, the first value being less than the second value.

5. The method of claim 1, wherein the at least one sleep interval comprises a plurality of sleep intervals being separated by a polling interval.

6. The method of claim 5, wherein a duration of each subsequent sleep interval of the plurality of sleep intervals is greater than a preceding sleep interval.

7. The method of claim 5, wherein the duration of each of the plurality of sleep intervals exponentially increases during the back-off period.

8. The method of claim 5, wherein a duration of the back-off period comprises any one or more of:
a predetermined period of time;
a predetermined number of polling intervals; and
a predetermined number of sleep intervals.

9. The method of claim 8, wherein the duration of the back-off period is greater than the first period of time.

10. The method of claim 1, wherein entering the non-autonomous sleep state comprises the worker thread yielding by returning control and resources to a master thread.

11. The method of claim 1, wherein a duration of the yield period is based at least in part on a master thread of the worker thread.

12. The method of claim 1, wherein the wake-up signal is generated by a master thread of the worker thread.

13. The method of claim 1, wherein the wake-up signal comprises data being loaded into the at least one work queue associated with the worker thread.

14. A multi-thread computing system, the multi-thread computing system comprising processing circuitry, the processing circuitry configured to:
actively poll at least one work queue associated with a worker thread;
as a result of the at least one work queue being empty during the polling for a first period of time, cause the worker thread to alternately:
poll the at least one work queue during at least one polling interval; and
enter an autonomous sleep state during at least one sleep interval; and
as a result of the at least one work queue being empty during each polling interval of a back-off period, causing the worker thread) to enter a non-autonomous sleep state for a yield period controlled by a wake-up signal.

15. The multi-thread computing system of claim 14, wherein each of the at least one polling interval has a predetermined duration.

16. The multi-thread computing system of claim 1, wherein each of the at least one sleep interval has a predetermined duration.

17. The multi-thread computing system of claim 14, wherein the duration of each of the at least one sleep interval is varied from a first value to a second value during the back-off period, the first value being less than the second value.

18. The multi-thread computing system of claim 14, wherein the at least one sleep interval comprises a plurality of sleep intervals being separated by a polling interval.

19. The multi-thread computing system of claim 18,
wherein a duration of each subsequent sleep interval of the plurality of sleep intervals is greater than a preceding sleep interval.

20. The multi-thread computing system of claim 18, wherein the duration of each of the plurality of sleep intervals exponentially increases during the back-off period.

21. The multi-thread computing system of claim 18, wherein
a duration of the back-off period comprises any one or more of:
a predetermined period of time;
a predetermined number of polling intervals; and
a predetermined number of sleep intervals.

22. The multi-thread computing system of claim 21, wherein the duration of the back-off period is greater than the first period of time.

23. The multi-thread computing system of claim 14, wherein the processing circuitry is further configured to cause the worker thread to enter the non-autonomous sleep state by being configured to cause the worker thread to yield by returning control and resources to a master thread.

24. The multi-thread computing system of claim 14, wherein a duration of the yield period is based at least in part on a master thread of the worker thread.

25. The multi-thread computing system of claim 14, wherein the wake-up signal is generated by a master thread of the worker thread.

26. The multi-thread computing system of claim 14, wherein the wake-up signal comprises data being loaded into the at least one work queue associated with the worker thread.

27. (canceled)

28. (canceled)
